(19) United States
(12) Patent Application Publication
(10) Pub. No.: US 2025/0287124 A1
(43) Pub. Date: Sep. 11, 2025

(54) PHOTOELECTRIC CONVERSION APPARATUS, PHOTOELECTRIC CONVERSION SYSTEM, MOVING BODY, AND EQUIPMENT

(71) Applicant: CANON KABUSHIKI KAISHA, Tokyo (JP)

(72) Inventor: HIDEYUKI ITO, Tokyo (JP)

(21) Appl. No.: 19/073,319

(22) Filed: Mar. 7, 2025

(30) Foreign Application Priority Data
Mar. 11, 2024 (JP) 2024-036759

(51) Int. Cl. H04N 25/773; H04N 25/76

(52) U.S. Cl. CPC H04N 25/773; H04N 25/7795

(57) ABSTRACT

A photoelectric conversion apparatus includes a first pixel having an avalanche photodiode configured to acquire IR light information, and a second pixel having an avalanche photodiode configured to acquire visible light information. Each of the first pixel and the second pixel includes a photon detection circuit configured to detect a photon signal and to output a photon detection signal; and a pixel counter configured to count the photon detection signal. The first pixel transmits the photon signal or the photon detection signal at the first pixel to the second pixel, and causes the pixel counter of the second pixel not to change a counter value or to make a subtraction from the counter value.

### BACKGROUND

### Technical Field

The present disclosure relates to a photoelectric conversion apparatus, a photoelectric conversion system, a moving body, and equipment.

### Description of the Related Art

An RGB-IR sensor capable of simultaneously acquiring an infrared (IR) image and a visible-light (red/green/blue “RGB”) image is known. In such an RGB-IR sensor, either an IR filter for acquiring an IR image or an RGB filter for acquiring a visible-light image is mounted on each pixel. Recently, imaging sensors using avalanche photodiodes (APD) are proposed widely. Japanese Translation of PCT Application No. 2022-549577 discloses a configuration of an RGB-IR sensor that uses a single-photon avalanche diode (SPAD) element as an imaging element.

Because the RGB-IR sensor captures an IR image and a visible-light image simultaneously, IR light and visible light both become incident on a sensor surface, simultaneously. However, because RGB pixels are IR-sensitive, if any IR light becomes incident on the RGB pixel, the IR light becomes mixed, as a false signal, in a resultant RGB image signal, and the RGB-IR sensors fail to obtain correct RGB image signals. Although Japanese Translation of PCT Application No. 2022-549577 has some description on leakage of incident light on adjacent pixels, there is no detailed discussion about the mixture of a false signal.

### SUMMARY

With the foregoing in view, it is an object of the present disclosure to provide a photoelectric conversion apparatus including an avalanche photodiode with a technology for suppressing the effect of false signals resultant of IR light (false IR signals) becoming incident on an RGB pixel.

According to some embodiments, a photoelectric conversion apparatus includes a first pixel having an avalanche photodiode configured to acquire IR (Infrared) light information; and a second pixel having an avalanche photodiode configured to acquire visible light information, wherein each of the first pixel and the second pixel includes: a photon detection circuit configured to detect a photon signal and to output a photon detection signal; and a pixel counter configured to count the photon detection signal, and the first pixel transmits the photon signal or the photon detection signal at the first pixel to the second pixel, and causes the pixel counter of the second pixel not to change a counter value or to make a subtraction from the counter value.

According to some embodiments, a photoelectric conversion apparatus includes a first pixel having an avalanche photodiode configured to acquire IR light information; and a second pixel having an avalanche photodiode configured to acquire visible light information, wherein each of the first pixel and the second pixel includes: a photon detection circuit configured to detect a photon signal and to output a photon detection signal; a pixel counter configured to count the photon detection signal, the first pixel transmits flag information, which is based on the photon signal or the photon detection signal at the first pixel, to the second pixel, and the second pixel outputs the flag information as well as a counter value of the photon detection signal at the second pixel.

According to some embodiments, a photoelectric conversion system includes the photoelectric conversion as described above; and a signal processing unit configured to generate an image by using a signal output from the photoelectric conversion apparatus.

According to some embodiments, a moving body includes the photoelectric conversion apparatus as described above, wherein the moving body further comprises a control unit configured to control a movement of the moving body by using a signal output from the photoelectric conversion apparatus.

According to some embodiments, equipment includes the photoelectric conversion apparatus as described above; and at least any one of: an optical apparatus corresponding to the photoelectric conversion apparatus; a control apparatus configured to control the photoelectric conversion apparatus; a processing apparatus configured to process a signal output from the photoelectric conversion apparatus; a display apparatus configured to display information acquired by the photoelectric conversion apparatus; a storage apparatus configured to store the information acquired by the photoelectric conversion apparatus; and a mechanical apparatus configured to operate based on the information acquired by the photoelectric conversion apparatus.

Further features of the present invention will become apparent from the following description of exemplary embodiments with reference to the attached drawings.

### BRIEF DESCRIPTION OF THE DRAWINGS

FIG. 1 is schematic of a layout of a color filter according to the embodiment.

FIG. 2 is an SPAD pixel circuit diagram corresponding to one pixel according to the embodiment.

FIG. 3 is a pixel circuit diagram corresponding to 2×2 pixels according to the first embodiment (active driving).

FIG. 4 is a pixel circuit diagram corresponding to 2×2 pixels according to the first embodiment (passive driving).

FIG. 5 is a pixel circuit diagram corresponding to 2×2 pixels according to a second embodiment.

FIG. 6 is a pixel circuit diagram corresponding to 2×2 pixels, according to a third embodiment.

FIG. 7 is a pixel circuit diagram corresponding to 2×2 pixels, according to a fourth embodiment.

FIG. 8 is a timing chart for driving a pixel, according to a fifth embodiment.

FIG. 9 is a schematic for explaining a photoelectric conversion system according to a six embodiment.

FIGS. 10A and 10B are schematics for explaining a photoelectric conversion system and a moving body, respectively, according to a seventh embodiment.

FIG. 11 is a schematic for explaining a distance image sensor according to an eighth embodiment.

FIG. 12 is a schematic for explaining an endoscopic surgery system according to a ninth embodiment.

FIGS. 13A and 13B are schematics for explaining smart glasses according to a tenth embodiment.

FIGS. 14A and 14B are schematics for explaining an electronic device according to an eleventh embodiment.

FIG. 15 is a schematic for explaining equipment according to a twelfth embodiment.

### DESCRIPTION OF THE EMBODIMENTS

Embodiments described below are some specific embodiments of the technical idea according to the present invention, and are not intended to limit the scope of the present invention in any way. The sizes or positional relationships of the members illustrated in each of the drawings are sometimes exaggerated, for the purpose of clarifying the description. In the description hereunder, the same configurations are given the same reference numerals, and explanations thereof are sometimes omitted.

The embodiments of the present invention will now be explained with reference to drawings. In the description hereunder, terms indicating specific directions or positions (e.g., “up”, “down”, “right”, “left” and other terms including these terms) are used, as necessary. These terms are used to make the embodiments easy to understand by referring to the drawings, and are not intended to limit the technical scope of the present invention in any way.

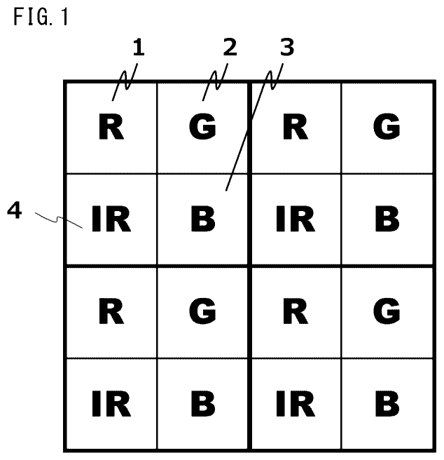

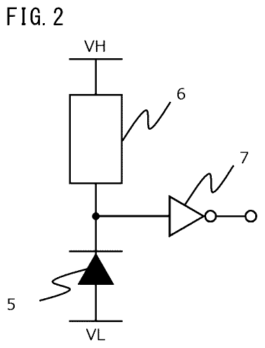

Common elements of photoelectric conversion apparatuses among the embodiments of the present invention will now be explained with reference to FIGS. 1 and 2. In the description hereunder, a circuit including an avalanche photodiode will be sometimes referred to as an SPAD pixel or an SPAD pixel circuit, for the convenience of explanation, but the avalanche photodiode in the present disclosure is not limited to an SPAD.

FIG. 1 is schematic of a layout of color filters in an RGB-IR sensor that uses an SPAD element, in a plan view. The RGB-IR sensor includes an R pixel filter 1, a G pixel filter 2, a B pixel filter 3, and an IR pixel filter 4. An R pixel, a G pixel, and a B pixel are collectively referred to as RGB pixels. 2×2 pixels including one pixel provided with an IR pixel filter, and three pixels provided with RGB pixel filters are arranged repetitively, as a unit, in a two-dimensional array.

FIG. 2 is a diagram of a SPAD pixel circuit corresponding to one pixel. This SPAD pixel circuit includes an avalanche photodiode (APD) 5, a quenching and recharging circuit 6, and an inverter (buffer) circuit 7. When light becomes incident on the APD 5, a photoelectric conversion takes place in the photosensitive region, and generates an electric charge. To the anode of the APD 5, a voltage VL is supplied. To the cathode of the APD 5, a voltage VH higher than the voltage VL supplied to the anode is supplied. Supplied to the anode and the cathode are reverse bias voltages enabling the APD 5 to perform an avalanche amplification operation. With such voltages applied, when the electric charge generated in the APD 5 passes across a high-electric field region, avalanche amplification occurs, and a large amount of electric charge is generated. A change in the voltage resultant of this electric charge amplification is detected as a photon detection signal, via the inverter circuit 7.

Among the operation modes of the APD supplied with such reverse bias voltages, there is a Geiger mode in which the APD is caused to operate with a potential difference greater than the breakdown voltage between the anode and the cathode, and a linear mode in which the APD is caused to operate with a potential difference near or equal to or lower than breakdown voltage, between the anode and the cathode. An APD caused to operate in the Geiger mode is called an SPAD. For example, the voltage VL is −30 V, and the voltage VH is 1 V. It is also possible for the voltage VL to be 0 V, and for the voltage VH to be 33 V, as another example.

The quenching and recharging circuit 6 can control the voltages to be applied to the APD 5 after detecting photons, so as to enable the APD 5 to detect photons again. As one example of the configuration of the quenching and recharging circuit, the following configuration may be used. A switch is connected to a power line supplied with the driving voltage VH, and to the APD 5. The switch is connected to one of nodes of the anode and the cathode of the APD 5. The switch then switches the potential difference between the anode and the cathode of the APD 5 between a first potential difference at which avalanche amplification occurs, and a second potential difference at which avalanche amplification does not occur. In the description hereunder, switching from the second potential difference to the first potential difference will be sometimes referred to as switching the switch ON, and switching from the first potential difference to the second potential difference will be sometimes referred to as switching the switch OFF. This switch functions as a quench element.

The switch may be configured as a MOS transistor, for example. A switch control signal is then applied to the gate electrode of the MOS transistor serving as the switch. By controlling the voltage applied to the gate electrode of the switch, switching of the switch between ON and OFF can be controlled.

The inverter circuit 7 rectifies a change in the potential at the cathode of the APD 5, such a change resultant of a detection of a photon, and outputs a pulse signal. Referring to the node on the input side of the inverter circuit 7 as a node A, and the node on the output side as a node B, the inverter circuit 7 changes the output potential from the node B in accordance with whether the input potential at the node A is equal to or higher than a predetermined potential, or lower than the predetermined potential. In FIG. 2, an example that uses one inverter is illustrated, but a circuit including a plurality of serially connected inverters, or any other circuit having the effect of waveform rectification may also be used.

A photoelectric conversion apparatus according to each embodiment will now be explained.

### First to Third Embodiments

In the first to third embodiments, the photoelectric conversion apparatus includes a first pixel provided with an IR-pixel filter on the light-incident surface, and including an avalanche photodiode configured to acquire IR light information. The photoelectric conversion apparatus also has a second pixel provided with an RGB pixel filter on the light-incident surface, and including an avalanche photodiode configured to acquire visible light information. Each of these pixels also includes a photon detection circuit configured to detect a photon signal that is based on a photon becoming incident thereon, and to output the photon signal, and a pixel counter for keeping track of the count of photon detection signals. The first pixel corresponds to an IR pixel, and the second pixel corresponds to an RGB pixel.

When the IR pixel (first pixel) detects a photon signal resulting from IR light, the IR pixel transmits either the signal (photon signal) itself detected by the avalanche photodiode in the IR pixel or a signal having passed through the photon detection circuit in the IR pixel (photon detection signal), to the RGB pixel (second pixel), and operates so as not to change the counter value of the pixel counter in the RGB pixel (second pixel) or to make a subtraction from the counter value of the pixel counter.

The IR light becoming incident on the RGB pixel (second pixel) is a flux of light having a certain area. In particular, when the pixel size of the pixels is small, it is highly likely for IR light to become incident on a plurality of nearby pixels, and to cause the counter to increment, as a false signal. By configuring an RGB pixel (second pixel) adjacent to an IR pixel (first pixel) to handle a photon detection signal output from the RGB pixel when the IR pixel has detected IR light, as a false signal, and to not increment the counter, it is possible to suppress the effect of the false IR signal, advantageously.

Among the RGB pixels to which IR pixels are adjacent, any RGB pixel adjacent to an IR pixel having detected the IR light considers that the RGB pixel has counted a photon signal that is based on the IR light erroneously as a photon signal based on visible light. Such an RGB pixel therefore operates, in response to a photon signal or a photon detection signal received from the adjacent IR pixel, to make a subtraction from the counter value of the photon detection signal counter of the RGB pixel. By contrast, any RGB pixel adjacent to an IR pixel having not detected any IR light increments the value of the photon detection signal counter of the RGB pixel, regardless of a photon signal or a photon detection signal received from the IR pixel. Note that being adjacent herein means pixels being adjacent, and there may be some element between the IR pixel and the RGB pixel.

The first to third embodiments will now be described in detail.

### First Embodiment

The first embodiment is an embodiment in which the RGB pixel (second pixel) includes a signal control circuit. The signal control circuit can control an input to the pixel counter of the RGB pixel (second pixel) on the basis of a photon signal or a photon detection signal received from the IR pixel (first pixel). The signal control circuit then controls not to change or to make a subtraction from the counter value of the pixel counter of the RGB pixel (second pixel) when the IR pixel (first pixel) detects a photon signal resultant of IR light. With such a configuration, it is possible to suppress the effect of false IR signals, advantageously.

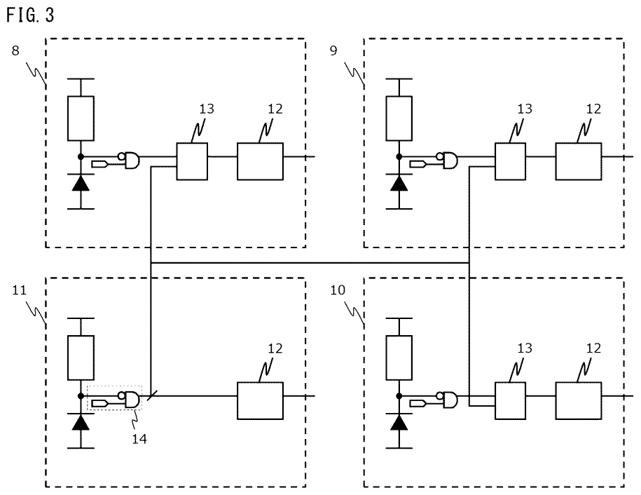

As one example, FIG. 3 illustrates a pixel circuit diagram of 2×2 pixels of an RGB-IR sensor. This RGB-IR sensor includes an R pixel 8, a G pixel 9, a B pixel 10, and an IR pixel 11, and a pixel counter 12 and a photon detection circuit 14 that are provided correspondingly to each of these pixels. Each of the R pixel 8, the G pixel 9, and the B pixel 10 further includes a signal control circuit 13. The arrangement of the pixels (8, 9, 10, 11) in FIG. 3 is in a positional relationship corresponding to the arrangement of the pixels (1, 2, 3, 4) in FIG. 1. Each of these pixels has a single-pixel SPAD pixel circuit illustrated FIG. 2, and a photon detection signal detected at each of these pixels is counted at the pixel counter 12 corresponding thereto, and then output to the outside of the sensor. An output node of the photon detection circuit 14 included in the IR pixel 11 is connected to the signal control circuits 13 of the R pixel 8, the G pixel 9, and the B pixel 10.

When the photon detection circuit 14 of the IR pixel (first pixel) detects a photon signal resultant of IR light, as illustrated in FIG. 3, the photon detection circuit 14 transmits the photon detection signal at the IR pixel to the signal control circuits 13 of the RGB pixels (second pixels). In each of the RGB pixels, the signal control circuit 13 operates not to change the counter value of the pixel counter at the RGB pixel (second pixel), or to make a subtraction from the counter value of the pixel counter. With such a configuration, it is possible to suppress the effect of false IR signals, advantageously.

As one example, the signal control circuit 13 may be configured as an AND circuit receiving inputs of the photon detection signal of the RGB pixel (second pixel), and the photon detection signal of the IR pixel (first pixel) via a NOT circuit. In the description of this embodiment, a photon detection signal that is an output signal from the photon detection circuit 14 of the IR pixel (first pixel) is input to the signal control circuit 13 of the RGB pixels (second pixels), but the photon signal of the IR pixel (first pixel) may be transmitted to the RGB pixel (second pixel).

FIG. 3 is a circuit diagram, under an assumption of active driving, in which a clock signal is input to the quenching and recharging circuit 6 and the photon detection circuit 14, and the SPAD element is recharged and caused to perform a photon detection once in every time interval. By using such a configuration, favorable imaging can be achieved even when the brightness of a subject is high. This configuration is applicable not only to the first embodiment but also to the second to fifth embodiments to be described later, and the same kind of effects can be achieved, advantageously.

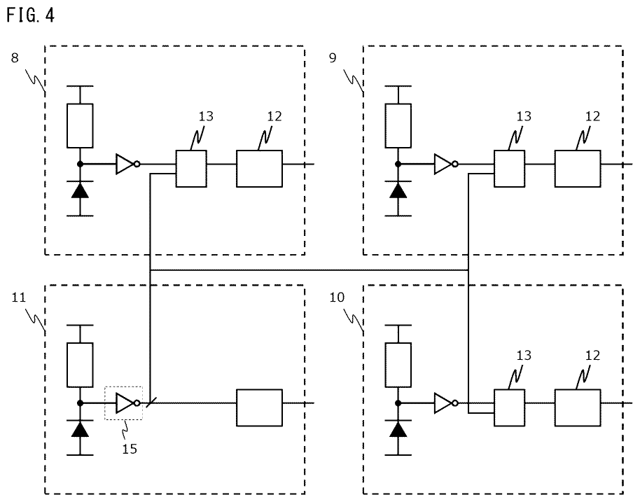

By contrast, FIG. 4 is a circuit diagram under an assumption of passive driving, in which no clock signal is input to the quenching and recharging circuit 6 and a photon detection circuit 15, and the SPAD element operates passively at the timing when a photon becomes incident. As an effect achieved in the circuit diagram illustrated in FIG. 4, the effect of false IR signals can be suppressed, in the same manner as the circuit diagram in FIG. 3 described above.

In both of the driving methods of active driving and passive driving described above, the effect of false IR signals can be suppressed, advantageously. In the drawings used in the embodiments described below, active driving is used, but the same kind of configuration is applicable to passive driving, and the same kind of effect can be achieved, advantageously. Furthermore, the pixel arrangement and the pixel circuit are also applicable to a configuration other than 2×2 pixels, in relation to the RGB pixels adjacent to the IR pixel.

### Second Embodiment

A second embodiment is an embodiment in which the RGB pixels (second pixels) do not have the signal control circuit. The photon detection circuit of the RGB pixel is enabled to control the pixel counter of the RGB pixel on the basis of a photon signal or a photon detection signal received from the IR pixel (first pixel). When the IR pixel (first pixel) detects a photon signal resultant of IR light, the photon detection circuit operates not to change the counter value of the pixel counter at the RGB pixel (second pixel) or to make a subtraction from the counter value of the pixel counter. With such a configuration, too, it is possible to suppress the effect of false IR signals, advantageously.

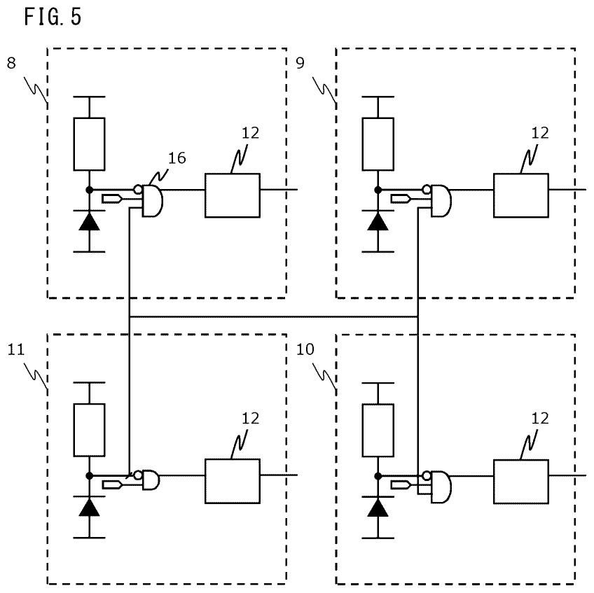

One example of the second embodiment will now be explained with reference to FIG. 5. The second embodiment is a modification of the first embodiment. The configuration illustrated in FIG. 5 is different from that of the first embodiment in that each of the RGB pixels does not have the signal control circuit 13, but has a photon detection circuit 16 with three inputs. The photon detection circuit 16 in each of the RGB pixels (8, 9, 10) is configured to receive an input of a signal that is based on the photon detected by the IR pixel 11. The photon detection circuit 16 in each of the RGB pixels is also configured to perform a logical operation on the signal received from the IR pixel 11, an output from the APD 5 in the RGB pixel, and a clock signal. By using such a configuration, it is possible to suppress the effect of false IR signals, advantageously, without providing the signal control circuit 13 prior to the pixel counter 12, and to reduce the circuit footprint.

As illustrated in FIG. 5, when a photon signal resultant of IR light is detected at the IR pixel (first pixel), the photon signal or the photon detection signal of the IR pixel is transmitted to the photon detection circuits of the RGB pixels (second pixels). The photon detection circuit in each of the RGB pixels (second pixels) then operates not to change the counter value of the pixel counter at the second pixel, or to make a subtraction from the counter value of the pixel counter. With such a configuration, it is possible to suppress the effect of false IR signals, advantageously.

### Third Embodiment

A third embodiment is an embodiment in which the RGB pixels (second pixels) do not have the signal control circuit. Instead, each of the RGB pixels (second pixels) has an up/down counter as the pixel counter of the pixel. The up/down counter operates to increment the count when the RGB pixel corresponding thereto detects a photon signal. The up/down counter of the RGB pixel also operates to decrement the counter value when a photon signal or a photon detection signal is received from the IR pixel (first pixel), on the basis of a photon signal or a photon detection signal received from the IR pixel. With such a configuration, too, it is possible to suppress the effect of false IR signals, advantageously.

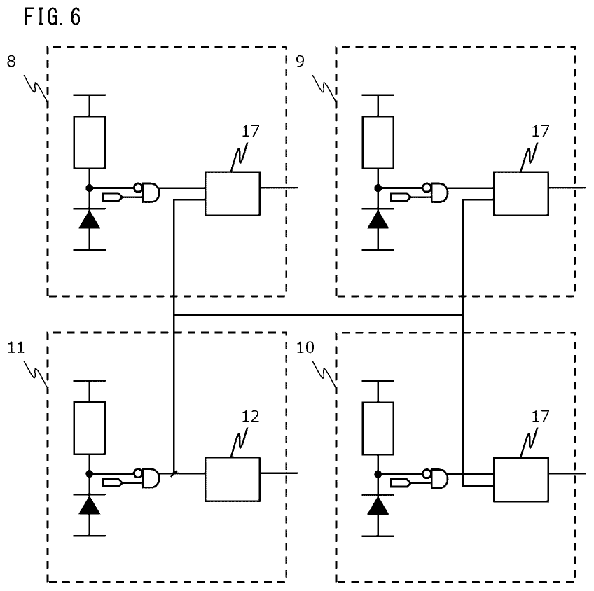

One example of the third embodiment will now be explained with reference to FIG. 6. In the third embodiment, an up/down counter 17 is used as the pixel counter of an RGB pixel. The up/down counter 17 receives an output signal from the APD 5 in the RGB pixel, as well as an output signal from the IR pixel. In the first embodiment, the counter inputs are controlled by the signal control circuit 13, and, in the second embodiment, by the photon detection circuit 16. By contrast, in the third embodiment, the counter value of the up/down counter 17 is incremented for a photon detected at the RGB pixel (8, 9, 10), and the counter value of the up/down counter 17 is decremented for a photon detected at the IR pixel 11 adjacent to the RGB pixel. With such a configuration, it is possible to suppress the effect of false IR signals, advantageously.

### Fourth Embodiment

In the fourth embodiment, the photoelectric conversion apparatus includes a first pixel having an avalanche photodiode configured to acquire IR light information, and a second pixel having an avalanche photodiode configured to acquire visible light information. Each of these pixels includes a photon detection circuit configured to detect a photon signal, and to output the photon detection signal, and a pixel counter for counting the number of photon detection signals. The first pixel corresponds to the IR pixel, and the second pixel corresponds to the RGB pixel, in the same manner as in the first embodiment.

When the IR pixel (first pixel) detects a photon signal resultant of IR light, the IR pixel transmits flag information corresponding to the photon signal or the photon detection signal from the IR pixel to the adjacent RGB pixels (second pixels). Each of the RGB pixels operates to output the flag information, together with the counter value of the RGB photon detection signals. With such a configuration, it is possible to suppress the effect of false IR signals, advantageously.

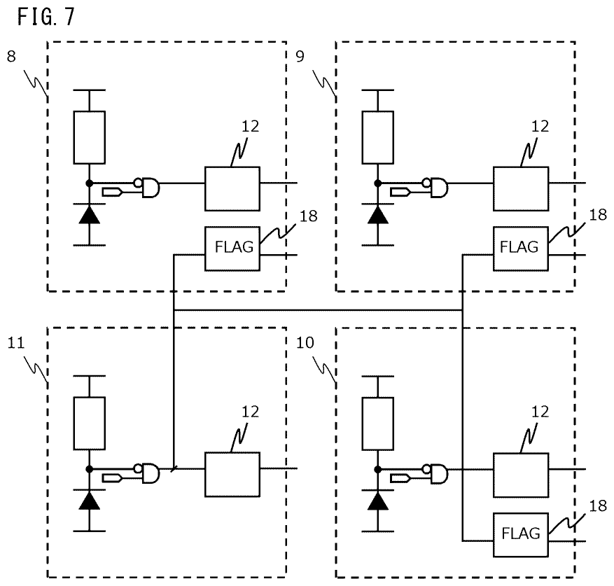

One example of the fourth embodiment will now be explained with reference to FIG. 7. Each of the RGB pixels in the photoelectric conversion apparatus according to the fourth embodiment includes a flag information circuit 18. In this embodiment, the RGB pixel counts all of the photon detection signals generated in the RGB pixel; but when the IR pixel detects a photon signal, the IR pixel transmits the result to the flag information circuits 18 of the adjacent RGB pixels as the flag information. Each of the RGB pixels then outputs the flag information, together with the counter value of the pixel counter 12, to the external of the sensor. By using the flag information, an image signal processor (ISP) receiving the signal from the sensor is allowed to execute the process of removing the false IR signal, at a higher speed. Therefore, it is possible to suppress the effect of false IR signals, advantageously.

### Fifth Embodiment

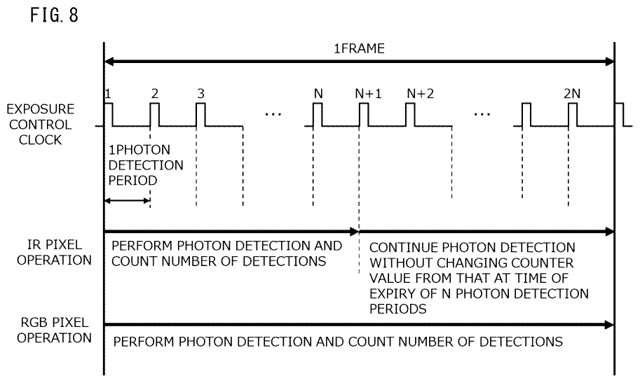

A modification of the pixel driving methods according to the first to fourth embodiments will now be explained with reference to FIG. 8. In the first to fourth embodiments described above, when active driving is used for driving the SPAD element, the quenching and recharging circuit 6 and the photon detection circuit 14 (15, 16) operate to be ready for detecting photons once every time interval. As an exposure control clock, the voltage to be applied to the APD 5 is recharged by the same number of times as the number of bits in the pixel counter, per frame.

As a modification of the embodiments, an example in which the exposure control clock is set to a frequency greater than the number of bits of the pixel counter (denoted as N in FIG. 8) will be illustrated. In other words, the fifth embodiment is an embodiment in which the number of times the photon detection is executed per frame is greater than the number of counter bits in each pixel. In the IR pixel, an ordinary operation is repeated until the number of operations reaches the number corresponding to the number of bits of the pixel counter, and then, photon detections are continued, with the counter value being maintained, for the purpose of the false signal detection in the RGB pixels. By contrast, in each of the RGB pixels, photons are kept detected and the number of photon detections are kept counted over one frame, and a sensor output is made upon expiry of the one frame. Because the RGB pixel counter is not incremented when there are any detections of a false IR signal, if the detections are made only by the number of times corresponding to the number of bits of the pixel counter, it is not possible to use up the entire counter bits. However, by using the driving method described above, it is possible to increase the number of times photon detections are made and the number of photons counted per frame in the RGB pixel.

Next, photoelectric conversion systems, moving bodies and equipment according to some embodiments are described below.

### Sixth Embodiment

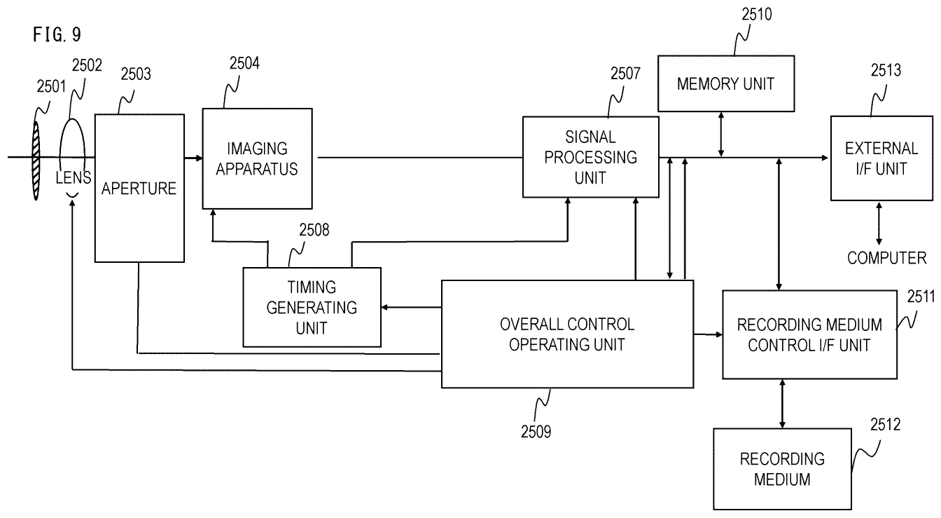

A photoelectric conversion system according to the present embodiment will be described with reference to FIG. 9. FIG. 9 is a block diagram showing a schematic configuration of the photoelectric conversion system according to the present embodiment.

The photoelectric conversion apparatuses described in the first to fifth embodiments can be applied to various photoelectric conversion systems. Each of the photoelectric conversion systems includes at least the photoelectric conversion apparatuses according to any of the embodiments described above and a signal processing portion that processes signals output from the photoelectric conversion apparatus. Examples of devices to which such a photoelectric conversion system can be applied include a digital still camera, a digital camcorder, a monitoring camera, a copier, a facsimile, a mobile phone, a vehicle-mounted camera, an observation satellite, a sensor, and a measuring instrument. In addition, camera modules provided with an optical system such as a lens and an imaging apparatus are also included in devices to which a photoelectric conversion system is applied. FIG. 9 illustrates a block diagram of a digital still camera as an example of such devices.

The photoelectric conversion system illustrated in FIG. 9 has an imaging apparatus 2504 as an example of the photoelectric conversion apparatus and a lens 2502 that causes an optical image of a subject to be formed on the imaging apparatus 2504. In addition, the photoelectric conversion system has an aperture 2503 for making a light amount that passes through the lens 2502 variable and a barrier 2501 for protecting the lens 2502. The lens 2502 and the aperture 2503 are optical systems for collecting light to the imaging apparatus 2504. The imaging apparatus 2504 is the photoelectric conversion apparatus (imaging apparatus) according to any of the embodiments described above and converts an optical image having been formed by the lens 2502 into an electric signal.

The photoelectric conversion system also has a signal processing portion 2507 which is an image generating portion for generating an image by processing an output signal that is output from the imaging apparatus 2504. The signal processing portion 2507 performs operations in which the output signal is subjected to various corrections and compression when necessary and image data is output. The signal processing portion 2507 may be formed on a semiconductor substrate provided with the imaging apparatus 2504 or formed on a semiconductor substrate that is separate from the imaging apparatus 2504. In addition, the imaging apparatus 2504 and the signal processing portion 2507 may be formed on a same semiconductor substrate.

The photoelectric conversion system further has a memory portion 2510 for temporarily storing image data and an external interface portion (an external I/F portion) 2513 for communicating with an external computer or the like. Furthermore, the photoelectric conversion system has a recording medium 2512 such as a semiconductor memory for recording or reading imaging data and a recording medium control interface portion (a recording medium control I/F portion) 2511 for performing recording or reading with respect to the recording medium 2512. The recording medium 2512 may be built into the photoelectric conversion system or may be attachable to and detachable from the photoelectric conversion system.

Furthermore, the photoelectric conversion system has an overall control operating portion 2509 that performs various arithmetic operations and controls the entire digital still camera and a timing generating portion 2708 that outputs various timing signals to the imaging apparatus 2504 and the signal processing portion 2507. In this case, the timing signals and the like may be input from outside and the photoelectric conversion system need at least have the imaging apparatus 2504 and the signal processing portion 2507 that processes an output signal that is output from the imaging apparatus 2504.

The imaging apparatus 2504 outputs an imaging signal to the signal processing portion 2507. The signal processing portion 2507 performs predetermined signal processing on the imaging signal output from the imaging apparatus 2504 and outputs image data. The signal processing portion 2507 generates an image using the imaging signal.

As described above, according to the present embodiment, a photoelectric conversion system to which the photoelectric conversion apparatus (imaging apparatus) according to any of the embodiments described above is applied can be realized.

### Seventh Embodiment

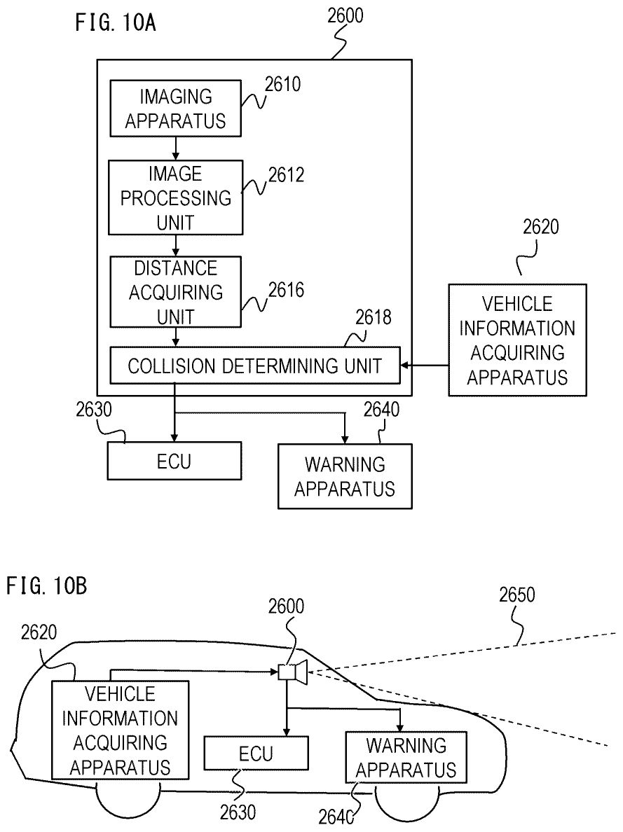

A photoelectric conversion system and a moving body according to the present embodiment will be described with reference to FIGS. 10A and 10B. FIG. 10A is a diagram showing a configuration of the photoelectric conversion system according to the present embodiment and FIG. 10B is a diagram showing a configuration of the moving body according to the present embodiment.

FIG. 10A shows an example of a photoelectric conversion system related to a vehicle-mounted camera. A photoelectric conversion system 2600 includes an imaging apparatus 2610 to which the photoelectric conversion apparatus (imaging apparatus) described in any one of the embodiments described above is applied. The photoelectric conversion system 2600 has an image processing unit 2612 that performs image processing on a plurality of pieces of image data acquired by the imaging apparatus 2610. In addition, the photoelectric conversion system 2600 has a distance acquiring unit 2616 that calculates a distance to an object and a collision determining unit 2618 that determines whether or not there is a possibility of a collision based on the calculated distance. In this case, the distance acquiring unit 2616 may acquire information on the distance to the object based on a ToF (Time of Flight) or may acquire distance information using parallax information or the like. Furthermore, the distance acquiring unit 2616 may acquire distance information by combining ranging according to ToF and ranging based on a phase difference between pixels. In other words, distance information is information related to a parallax, a defocus amount, a distance to the object, or the like. The collision determining unit 2618 may determine a possibility of a collision using any of these pieces of distance information. The distance information acquiring means may be realized by exclusively-designed hardware or may be realized by a software module. Alternatively, the distance information acquiring means may be realized by an FPGA (Field Programmable Gate Array), an ASIC (Application Specific Integrated Circuit), or the like, or a combination thereof.

The photoelectric conversion system 2600 is connected to a vehicle information acquiring apparatus 2620 and is capable of acquiring vehicle information such as a vehicle speed, a yaw rate, and a steering angle. In addition, an ECU 2630 which is a control apparatus that outputs a control signal causing a vehicle to generate a braking force based on a determination result of the collision determining unit 2618 is connected to the photoelectric conversion system 2600. Furthermore, the photoelectric conversion system 2600 is also connected to a warning apparatus 2640 that issues a warning to a driver based on a determination result of the collision determining unit 2618. For example, when it is found that the possibility of a collision is high as a determination result of the collision determining unit 2618, the ECU 2630 performs vehicle control involving applying the brakes, releasing the gas pedal, suppressing engine output, or the like to avoid a collision and/or reduce damage. The warning apparatus 2640 issues a warning to a user by sounding an alarm, displaying warning information on a screen of a car navigation system or the like, vibrating a seat belt or a steering wheel, or the like.

In the present embodiment, an image of a periphery of the vehicle such as the front or the rear of the vehicle is picked up by the photoelectric conversion system 2600. FIG. 10B shows the photoelectric conversion system when imaging of the front of the vehicle (an imaging range 2650) is performed. The vehicle information acquiring apparatus 2620 sends an instruction to the photoelectric conversion system 2600 or the imaging apparatus 2610. According to such a configuration, accuracy of ranging can be further improved.

While an example of controlling a vehicle so as to prevent a collision with another vehicle has been described above, the photoelectric conversion system can also be applied to controlling automated driving so that the vehicle follows another vehicle, controlling automated driving so that the vehicle stays within a lane, and the like. In addition, the photoelectric conversion system is not limited to a vehicle such as an automobile and can also be applied to a moving body (moving apparatus) such as a ship, an airplane, or an industrial robot. The moving body includes one of or both of a driving force generating unit that generates a driving force mainly used for movement of the moving body and a rotating member that is mainly used for movement of the moving body. The driving force generating unit can be an engine, a motor, or the like. The rotating member can be a tire, a wheel, a screw of a ship, a propeller of a flight vehicle, or the like. Moreover, besides moving bodies, the photoelectric conversion system can be applied to a wide variety of apparatuses that utilize object recognition such as an intelligent transportation system (ITS).

### Eighth Embodiment

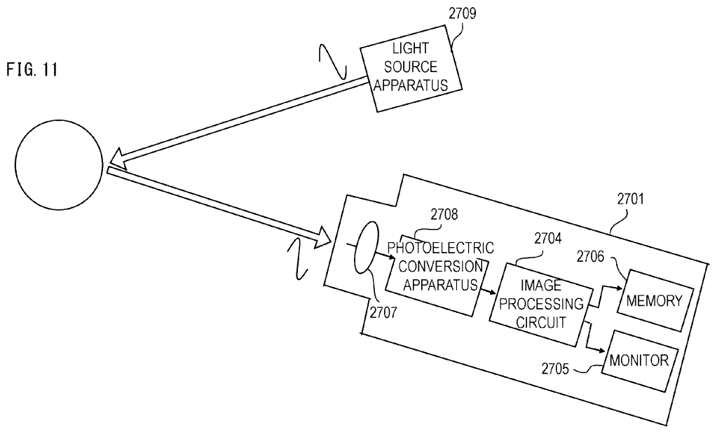

A photoelectric conversion system according to the present embodiment will be described with reference to FIG. 11. FIG. 11 is a block diagram showing a configuration example of a distance image sensor that is the photoelectric conversion system according to the present embodiment.

As shown in FIG. 11, a distance image sensor 2701 is configured to include an optical system 2707, a photoelectric conversion apparatus 2708, an image processing circuit 2704, a monitor 2705, and a memory 2706. In addition, the distance image sensor 2701 is capable of acquiring a distance image in accordance with a distance to a subject by receiving light (modulated light or pulsed light) emitted toward the subject from a light source apparatus 2709 and reflected by a surface of the subject.

The optical system 2707 is configured with one or a plurality of lenses and guides image light (incident light) from the subject to the photoelectric conversion apparatus 2708 and forms an image on a light-receiving surface (a sensor unit) of the photoelectric conversion apparatus 2708.

The image processing circuit 2704 performs image processing for constructing a distance image based on the distance signal supplied from the photoelectric conversion apparatus 2708. In addition, a distance image (image data) obtained by the image processing is supplied to and displayed by the monitor 2705 or supplied to and stored (recorded) in the memory 2706.

With the distance image sensor 2701 configured as described above, applying one of the photoelectric conversion apparatuses described above enables, for example, a more accurate distance image to be acquired due to an improvement in ranging accuracy.

### Ninth Embodiment

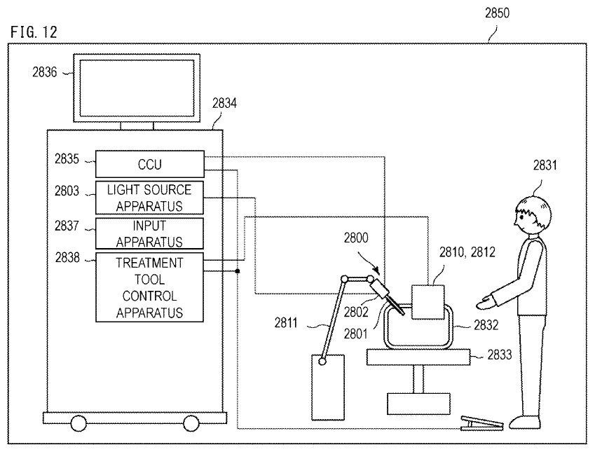

A photoelectric conversion system according to the present embodiment will be described with reference to FIG. 12. FIG. 12 is a diagram showing an example of a schematic configuration of an endoscopic surgery system that is the photoelectric conversion system according to the present embodiment.

FIG. 12 illustrates a situation where a technician (a physician) 2831 is using an endoscopic surgery system 2850 to operate on a patient 2832 on a patient bed 2833. As illustrated, the endoscopic surgery system 2850 is constituted of an endoscope 2800, a surgical instrument 2810, and a cart 2834 mounted with various apparatuses for an endoscopic surgery.

The endoscope 2800 is constituted of a lens barrel 2801 of which a region with a predetermined length from a distal end is to be inserted into a body cavity of the patient 2832 and a camera head 2802 connected to a base end of the lens barrel 2801. While the illustrated example features the endoscope 2800 being configured as a so-called rigid scope having a rigid lens barrel 2801, alternatively, the endoscope 2800 may be configured as a so-called flexible scope having a flexible lens barrel.

An opening into which an objective lens is fitted is provided at the distal end of the lens barrel 2801. A light source apparatus 2803 is connected to the endoscope 2800, and light generated by the light source apparatus 2803 is guided to the distal end of the lens barrel 2801 by a light guide provided so as to extend inside the lens barrel and emitted toward an observation object inside a body cavity of the patient 2832 via the objective lens. It should be noted that the endoscope 2800 may be a forward-viewing endoscope, an oblique-viewing endoscope, or a side-viewing endoscope.

An optical system and a photoelectric conversion apparatus are provided inside the camera head 2802 and reflected light (observation light) from the observation object is collected to the photoelectric conversion apparatus by the optical system. The observation light is photoelectrically converted by the photoelectric conversion apparatus and an electric signal corresponding to the observation light or, in other words, an image signal corresponding to an observed image is generated. As the photoelectric conversion apparatus, the photoelectric conversion apparatus according to any one of the embodiments described above can be used. The image signal is transmitted to a Camera Control Unit (CCU) 2835 as RAW data.

The CCU 2835 is constituted of a CPU (Central Processing Unit), a GPU (Graphics Processing Unit), or the like and comprehensively controls operations of the endoscope 2800 and a display apparatus 2836. In addition, the CCU 2835 receives an image signal from the camera head 2802 and subjects the image signal to various kinds of image processing for displaying an image based on the image signal such as development processing (demosaicing).

Under control exerted by the CCU 2835, the display apparatus 3036 displays an image based on the image signal subjected to image processing by the CCU 2835. The light source apparatus 2803 is constituted of a light source such as an LED (Light-Emitting Diode) and supplies the endoscope 2800 with irradiation light used when photographing a surgical site or the like.

An input apparatus 2837 is an input interface with respect to the endoscopic surgery system 2850. A user can input various kinds of information and input instructions to the endoscopic surgery system 2850 via the input apparatus 2837.

A treatment tool control apparatus 2838 controls drive of an energy treatment tool 2812 for cauterizing or incising tissue, sealing a blood vessel, or the like.

The light source apparatus 2803 that supplies the endoscope 2800 with irradiation light when photographing a surgical site can be constituted of a white light source constituted of an LED, a laser light source, or a combination thereof. When the white light source is constituted of a combination of RGB laser light sources, since output intensity and an output timing of each color (each wavelength) can be controlled with high accuracy, white balance of a captured image can be adjusted in the light source apparatus 2803. In addition, in this case, an image corresponding to each of RGB can be captured in a time-divided manner by having an observation object be irradiated with laser light from each of the RGB laser light sources in a time-divided manner and controlling drive of an imaging element of the camera head 2802 in synchronization with the irradiation timing. According to this method, a color image can be obtained without having to provide the imaging element with a color filter.

In addition, drive of the light source apparatus 2803 may be controlled such that intensity of output light changes at predetermined intervals. By controlling drive of imaging elements of the camera head 2802 in synchronization with a timing at which the intensity of light changes to acquire images in a time-divided manner and compositing the images, an image with a high dynamic range that is free of so-called blocked-up shadows and blown-out highlights can be generated.

Furthermore, the light source apparatus 2803 may be configured to be capable of supplying light in a predetermined wavelength band that accommodates special light observation. In special light observation, for example, wavelength dependence of absorption of light by body tissue is utilized. Specifically, predetermined tissue such as a blood vessel of a superficial portion of a mucous membrane is photographed with high contrast by irradiating light with a narrower band than irradiation light during normal observation (in other words, white light). Alternatively, in special light observation, fluorescent observation may be performed in which an image is obtained using fluorescent light generated by irradiating excitation light. In fluorescent observation, body tissue may be irradiated with excitation light and fluorescent light from the body tissue can be observed, a reagent such as indocyanine green (ICG) can be locally injected into body tissue and the body tissue can be irradiated with excitation light corresponding to a fluorescent wavelength of the reagent to obtain a fluorescent image, and the like. The light source apparatus 2803 may be configured to be capable of supplying narrow-band light and/or excitation light that accommodates such special light observation.

### Tenth Embodiment

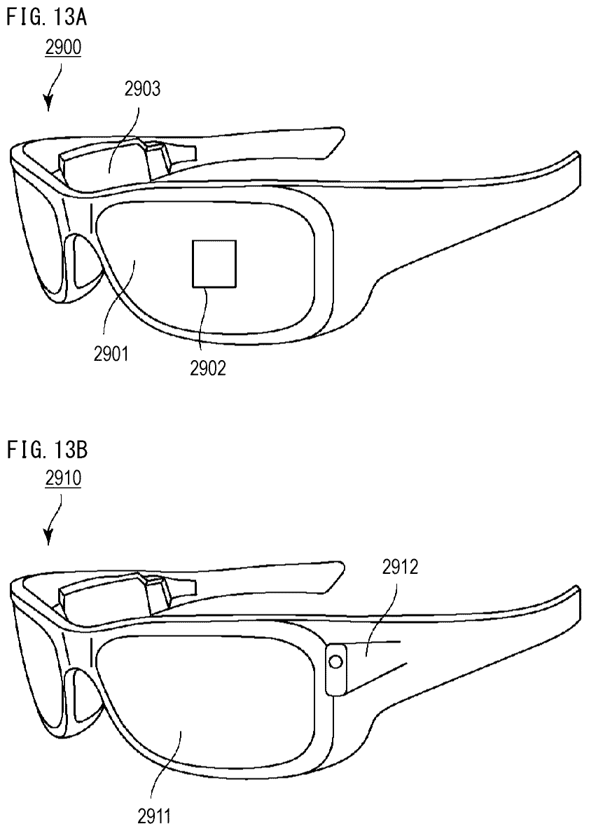

A photoelectric conversion system according to the present embodiment will be described with reference to FIGS. 13A and 13B. FIG. 13A illustrates eyeglasses 2900 (smart glasses) that is the photoelectric conversion system according to the present embodiment. The eyeglasses 2900 have a photoelectric conversion apparatus 2902. The photoelectric conversion apparatus 2902 is the photoelectric conversion apparatus (imaging apparatus) according to any one of the embodiments described above. In addition, a display apparatus including a light-emitting apparatus such as an OLED or an LED may be provided on a rear surface side of a lens 2901. There may be one or a plurality of photoelectric conversion apparatuses 2902. Alternatively, a plurality of types of photoelectric conversion apparatuses may be used in combination. An arrangement position of the photoelectric conversion apparatus 2902 is not limited to that shown in FIG. 13A.

The eyeglasses 2900 further include a control apparatus 2903. The control apparatus 2903 functions as a power source that supplies power to the photoelectric conversion apparatus 2902 and the display apparatus described above. In addition, the control apparatus 2903 controls operations of the photoelectric conversion apparatus 2902 and the display apparatus. An optical system for collecting light to the photoelectric conversion apparatus 2902 is formed in the lens 2901.

FIG. 13B illustrates eyeglasses 2910 (smart glasses) according to one application example. The eyeglasses 2910 include a control apparatus 2912 and the control apparatus 2912 is mounted with a photoelectric conversion apparatus that corresponds to the photoelectric conversion apparatus 2902 and a display apparatus. An optical system for projecting light emitted from the photoelectric conversion apparatus inside the control apparatus 2912 and the display apparatus is formed in the lens 2911 and an image is projected onto the lens 2911. The control apparatus 2912 functions as a power source that supplies power to the photoelectric conversion apparatus and the display apparatus and, at the same time, controls operations of the photoelectric conversion apparatus and the display apparatus. The control apparatus may have a line-of-sight detecting unit that detects a line-of-sight of a wearer. Infrared light may be used to detect a line-of-sight. An infrared light-emitting unit emits infrared light to the eyes of a user who is looking at a display image. A picked-up image of the eyes can be obtained by having an imaging unit including a light-receiving element detect reflected light from the eyes of emitted infrared light. Providing reducing means that reduces light from the infrared light-emitting unit to the display unit in a plan view enables a decline in image quality to be mitigated.

A line-of-sight of the user with respect to a display image can be detected from a picked-up image of eyes obtained by imaging with infrared light. Any known method can be applied to line-of-sight detection using a picked-up image of the eyes. For example, a line-of-sight detection method based on a Purkinje image due to reflection of irradiation light by the cornea can be used.

More specifically, line-of-sight detection processing based on a pupil-corneal reflection method is performed. Using the pupil-corneal reflection method, a line-of-sight of a user is detected by calculating a line-of-sight vector that represents an orientation (a rotation angle) of the eyes based on an image of a pupil included in a picked-up image of the eyes and a Purkinje image.

The display apparatus according to the present embodiment may have a photoelectric conversion apparatus including a light-receiving element and a display image of the display apparatus may be controlled based on line-of-sight information of the user from the photoelectric conversion apparatus.

Specifically, the display apparatus determines, based on the line-of-sight information, a first field-of-view region which the user focuses on and a second field-of-view region other than the first field-of-view region. The first field-of-view region and the second field-of-view region may be determined by the control apparatus of the display apparatus or regions determined by an outside control apparatus may be received as the first field-of-view region and the second field-of-view region. In a display region of the display apparatus, a display resolution of the first field-of-view region may be controlled to be higher than a display resolution of the second field-of-view region. In other words, the resolution of the second field-of-view region may be set lower than that of the first field-of-view region.

In addition, the display region may have a first display region and a second display region that differs from the first display region, and a region with high priority may be determined from the first display region and the second display region based on line-of-sight information. The first display region and the second display region may be determined by the control apparatus of the display apparatus or regions determined by an outside control apparatus may be received as the first display region and the second display region. A resolution of a region with high priority may be controlled to be higher than a resolution of a region other than the region with high priority. In other words, a resolution of a region of which a priority is relatively low can be lowered.

It should be noted that an AI (Artificial Intelligence) may be used to determine the first field-of-view region and a region with high priority. The AI may be a model configured to use an image of the eyes and a direction actually viewed by the eyes in the image as teacher data to estimate, from the image of the eyes, an angle of a line-of-sight and a distance to an object ahead of the line-of-sight. An AI program may be included in the display apparatus, the photoelectric conversion apparatus, or an external apparatus. When the external apparatus includes an AI program, an inference result by an AI is sent to the display apparatus via communication.

Display control based on visual recognition and detection can be preferably applied to smart glasses further including a photoelectric conversion apparatus that captures images of the outside. The smart glasses are capable of displaying captured external information in real-time.

### Eleventh Embodiment

The photoelectric conversion apparatuses and the photoelectric conversion systems described above can be applied to, for example, electronic devices such as so-called smartphones and tablets.

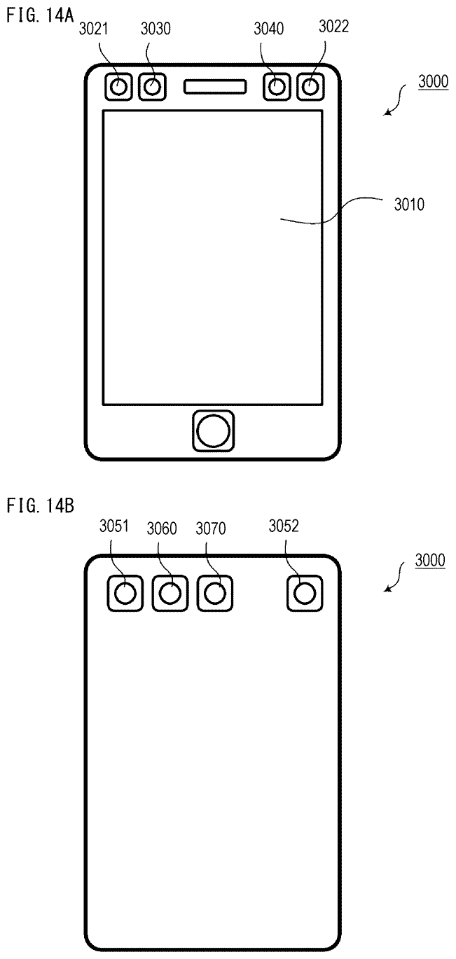

FIGS. 14A and 14B are diagrams showing an example of an electronic device 3000 to which a photoelectric conversion apparatus is mounted. FIG. 14A shows a front surface side of the electronic device 3000 and FIG. 14B shows a rear surface side of the electronic device 3000.

As shown in FIG. 14A, a display 3010 that displays an image is arranged at a center of the front surface of the electronic device 3000. In addition, front cameras 3021 and 3022 that use the photoelectric conversion apparatus, an IR light source 3030 that emits infrared light, and a visible light source 3040 that emits visible light are arranged along an upper side of the front surface of the electronic device 3000.

Furthermore, as shown in FIG. 14B, rear cameras 3051 and 3052 that use the photoelectric conversion apparatus, an IR light source 3060 that emits infrared light, and a visible light source 3070 that emits visible light are arranged along an upper side of the rear surface of the electronic device 3000.

In the electronic device 3000 configured as described above, by applying the photoelectric conversion apparatus described above, for example, an image with higher quality can be captured and a distance to a subject can be measured with high accuracy. Note that the photoelectric conversion apparatus can be applied to other electronic devices such as an infrared sensor, a ranging sensor using an active infrared light source, a security camera, and a personal authentication camera or a biometric camera. As a result, accuracy and performance of such electronic devices can be improved.

### Twelfth Embodiment

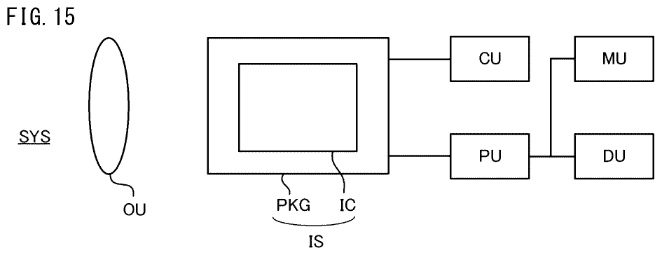

A photoelectric conversion system according to an eleventh embodiment will be described with reference to FIG. 15. FIG. 15 is a block diagram showing a schematic configuration of an imaging system SYS that is the photoelectric conversion system according to the eleventh embodiment. The imaging system SYS includes at least the photoelectric conversion apparatus according to any one of the embodiments described above and a signal processing unit that processes signals output from the photoelectric conversion apparatus.

The imaging system SYS is an information terminal that includes a camera and a photography function. The imaging system SYS is constructed using an imaging apparatus IS. The imaging apparatus IS can further include a package PKG that houses an imaging device IC. The package PKG can include a substrate on which the imaging device IC is fixed and a lid body that opposes the imaging device IC. The package PKG can include a connecting member (a member that connects a terminal provided on the substrate and a terminal provided on the imaging device IC) to each other. The imaging apparatus IS can mount a plurality of the imaging devices IC to a common package PKG by arranging the imaging devices IC side by side. Alternatively, the imaging apparatus IS can mount the imaging device IC and another semiconductor device IC to a common package PKG by stacking the imaging device IC and the semiconductor device IC on top of each other.

The imaging system SYS can include an optical system OU (optical apparatus) that forms an image on the imaging apparatus IS. In addition, the imaging system SYS can include at least any of a control apparatus CU, a processing apparatus PU, a display apparatus DU, and a storage apparatus MU. The control apparatus CU controls the imaging apparatus IS and the processing apparatus PU processes a signal obtained from the imaging apparatus IS. Furthermore, the display apparatus DU displays an image obtained from the imaging apparatus IS and the storage apparatus MU stores the image obtained from the imaging apparatus IS.

### Other Embodiments

While various apparatuses have been explained in the embodiments described above, a mechanical apparatus may be further provided. A mechanical apparatus in a camera can drive parts of the optical system for the purposes of zooming, focusing, and shutter operations. Alternatively, the mechanical apparatus in the camera can move the photoelectric conversion apparatus for vibration insulation.

In addition, the apparatus may be transportation equipment such as a vehicle, a ship, or a flight vehicle. A mechanical apparatus in the transportation equipment may be used as a moving apparatus. The apparatus as transportation equipment is suitable as an apparatus that transports the photoelectric conversion apparatus or an apparatus that assists and/or automates driving (operation) using the photography function. A processing apparatus for assisting and/or automating driving (operation) can perform processing for operating the mechanical apparatus as a moving apparatus based on information obtained by the photoelectric conversion apparatus.

The embodiments described above can be appropriately modified without departing from the technical concepts of the invention. It is to be understood that disclosed contents of the present specification include not only matters described in the present specification but also all matters that may be comprehended from the present specification and from the drawings that accompany the present specification.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-036759, filed on Mar. 11, 2024, which is hereby incorporated by reference herein in its entirety.

What is claimed is:

1. A photoelectric conversion apparatus comprising:
a first pixel having an avalanche photodiode configured to acquire IR (Infrared) light information; and
a second pixel having an avalanche photodiode configured to acquire visible light information, wherein
each of the first pixel and the second pixel includes:
a photon detection circuit configured to detect a photon signal and to output a photon detection signal; and
a pixel counter configured to count the photon detection signal, and
the first pixel transmits the photon signal or the photon detection signal at the first pixel to the second pixel, and causes the pixel counter of the second pixel not to change a counter value or to make a subtraction from the counter value.

2. The photoelectric conversion apparatus according to claim 1, wherein
the second pixel further includes a signal control circuit configured to control a signal input to the pixel counter of the second pixel,
the first pixel transmits the photon detection signal at the first pixel to the signal control circuit,
the signal control circuit performs a logical operation on the photon detection signal having been transmitted, and a photon detection signal at the second pixel.

3. The photoelectric conversion apparatus according to claim 1, wherein the photon detection circuit at the second pixel operates to cause the pixel counter of the second pixel not to change a counter value or to make a subtraction from the counter value.

4. The photoelectric conversion apparatus according to claim 3, wherein
the first pixel transmits the photon detection signal at the first pixel to the photon detection circuit, and
the photon detection circuit performs a logical operation on the photon detection signal having been transmitted, and a photon detection signal at the second pixel.

5. The photoelectric conversion apparatus according to claim 1, wherein
the pixel counter of the second pixel is an up/down counter,
the up/down counter increments a counter value of the pixel counter at the second pixel, and decrements the counter value on the basis of a photon signal or a photon detection signal transmitted from the first pixel.

6. The photoelectric conversion apparatus according to claim 1, wherein a clock signal is input to the photon detection circuit.

7. The photoelectric conversion apparatus according to claim 1, wherein the number of times photon detection is performed per one frame is greater than the number of counter bits of the pixel counter.

8. A photoelectric conversion apparatus comprising:
a first pixel having an avalanche photodiode configured to acquire IR light information; and
a second pixel having an avalanche photodiode configured to acquire visible light information, wherein
each of the first pixel and the second pixel includes:
a photon detection circuit configured to detect a photon signal and to output a photon detection signal;
a pixel counter configured to count the photon detection signal,
the first pixel transmits flag information, which is based on the photon signal or the photon detection signal at the first pixel, to the second pixel, and
the second pixel outputs the flag information as well as a counter value of the photon detection signal at the second pixel.

9. The photoelectric conversion apparatus according to claim 8, wherein a clock signal is input to the photon detection circuit

10. The photoelectric conversion apparatus according to claim 8, wherein the number of times photon detection is performed per frame is greater than the number of counter bits of the pixel counter.

11. A photoelectric conversion system comprising:
the photoelectric conversion apparatus according to claim 1; and
a signal processing unit configured to generate an image by using a signal output from the photoelectric conversion apparatus.

12. A moving body comprising the photoelectric conversion apparatus according to claim 1, wherein the moving body further comprises a control unit configured to control a movement of the moving body by using a signal output from the photoelectric conversion apparatus.

13. Equipment comprising:
the photoelectric conversion apparatus according to claim 1; and
at least any one of:
an optical apparatus corresponding to the photoelectric conversion apparatus;
a control apparatus configured to control the photoelectric conversion apparatus;
a processing apparatus configured to process a signal output from the photoelectric conversion apparatus;
a display apparatus configured to display information acquired by the photoelectric conversion apparatus;
a storage apparatus configured to store the information acquired by the photoelectric conversion apparatus; and
a mechanical apparatus configured to operate based on the information acquired by the photoelectric conversion apparatus.
